(19) United States
(12) Patent Application Publication
(10) Pub. No.: US 2016/0145104 A1
(43) Pub. Date: May 26, 2016

(54) METHOD FOR MAKING LITHIUM IRON PHOSPHATE

(71) Applicants: Jiangsu Huadong Institute of Li-ion Battery Co. Ltd., Zhangjiagang (CN); Tsinghua University, Beijing (CN)

(72) Inventors: XIANG-MING HE, Beijing (CN); LI WANG, Beijing (CN); FEI-FEI GAO, Beijing (CN); ZHONG-JIA DAI, Beijing (CN); XIAN-KUN HUANG, Beijing (CN); JI-XIAN WANG, Beijing (CN)

(21) Appl. No.: 15/011,637

(22) Filed: Jan. 31, 2016

Related U.S. Application Data
(63) Continuation of application No. PCT/CN2014/081524, filed on Jul. 2, 2014.

(30) Foreign Application Priority Data
Aug. 15, 2013 (CN) 201310354560.2

(51) Int. Cl. C01B 25/45; H01M 4/58

(52) U.S. Cl. CPC C01B 25/45; H01M 4/5825; H01M 2004/028

(57) ABSTRACT

A method for making a lithium iron phosphate suitable for use as a cathode active material comprises providing a lithium ion source solution and an iron phosphate, the lithium ion source solution comprising an organic solvent and a lithium chemical compound dissolved in the organic solvent. The lithium ion source solution and the iron phosphate are mixed and the mixture heated at a first temperature under a normal pressure to form a precursor solution, the first temperature being in a range from about 40° C. to about 90° C. The precursor solution is placed in a solvothermal reaction reactor and heated at a second temperature to form the lithium iron phosphate particles, the second temperature being higher than the first temperature.

### CROSS-REFERENCE TO RELATED APPLICATIONS

This application claims all benefits accruing under 35 U.S.C. §119 from China Patent Application No. 201310354560.2, filed on Aug. 15, 2013 in the China Intellectual Property Office, the content of which is hereby incorporated by reference. This application is a continuation under 35 U.S.C. §120 of international patent application PCT/CN2014/081524 filed Jul. 2, 2014.

### FIELD

The present disclosure relates to methods for making cathode active materials, and specifically relates to a method for making a lithium iron phosphate as the cathode active material.

### BACKGROUND

Lithium iron phosphate (LiFePO₄) has been investigated as a likely cathode active material of lithium ion batteries, because of its good safety performance, low-cost, and non-toxicity. However, the 3.4V voltage platform of the lithium iron phosphate limits an increase of energy density of the lithium ion battery. Compared to the lithium iron phosphate, a lithium manganese phosphate (LiMnPO₄) can greatly increase the energy density of the lithium ion battery. However, electrical conductivity and lithium ion diffusion rate of the lithium manganese phosphate are low, so unmodified lithium manganese phosphate as the cathode active material does not meet actual needs.

The lithium iron phosphate can be fabricated by using ferrous ion source through methods of solid reaction, co-precipitation, and hydrothermal synthesis. However, using ferrous ion source increases the cost. Divalent iron of the ferrous ion source is oxidized easily, so reaction conditions are difficult to control, and purity, electrochemical performance, and productivity of the lithium iron phosphate are very sensitive to reaction conditions.

The lithium iron phosphate fabricated by using ferric ion source agglomerates easily, has a non-uniform size, and a poor electrochemical performance.

### BRIEF DESCRIPTION OF THE DRAWINGS

Implementations are described by way of example only with reference to the attached figures.

FIG. 1 is a flowchart of an embodiment of a method for making a lithium iron phosphate.

FIG. 2 shows an X-ray diffraction (XRD) pattern of a solid phase substance in a precursor solution in Example 1.

FIG. 3 shows scanning electron microscope (SEM) images of iron phosphates before (upper) and after (lower) a water bath in Example 1.

FIG. 4 shows an XRD pattern of the lithium iron phosphate made by Example 1.

FIG. 5 shows an SEM image of the lithium iron phosphate made by Example 1.

FIG. 6 shows charge and discharge curves in the first cycle of the lithium iron phosphate made by Example 1.

FIG. 7 shows XRD patterns of the lithium iron phosphate made by Example 1 and Comparative Example 2-4.

FIG. 8 shows an SEM image of the lithium iron phosphate made by Comparative Example 5.

FIG. 9 shows charge and discharge curves in the first cycle of the lithium iron phosphate made by Comparative Example 5.

FIG. 10 shows an XRD pattern of the lithium iron phosphate made by Example 2.

FIG. 11 shows an SEM image of the lithium iron phosphate made by Example 2.

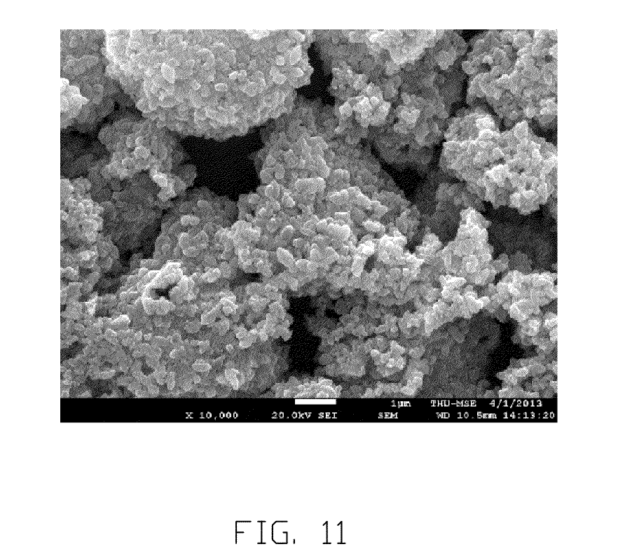

FIG. 12 shows charge and discharge curves in the first cycle of the lithium iron phosphate made by Example 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

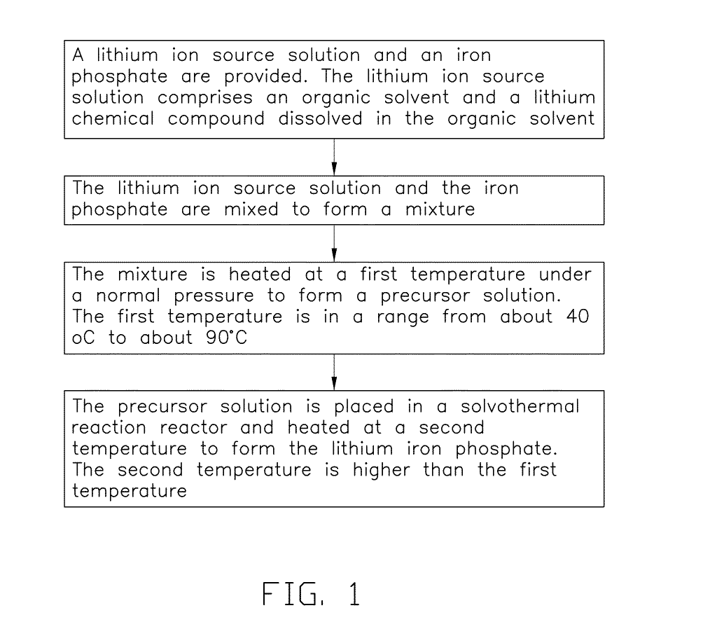

FIG. 1 presents a flowchart in accordance with an example embodiment. The embodiment of a method for making a lithium iron phosphate is provided by way of example, as there are a variety of ways to carry out the method. Each block shown in FIG. 1 represents one or more processes, methods, or subroutines carried out in the exemplary method. Additionally, the illustrated order of blocks is by example only and the order of the blocks can be changed. The exemplary method can begin at block S11. Depending on the embodiment, additional steps can be added, others removed, and the ordering of the steps can be changed.

At block S11, a lithium ion source solution and an iron phosphate are provided. The lithium ion source solution comprises an organic solvent and a lithium chemical compound dissolved in the organic solvent.

At block S12, the lithium ion source solution and the iron phosphate are mixed to form a mixture.

At block S13, the mixture is heated at a first temperature under normal pressure to form a precursor solution. The first temperature is in a range from about 40° C. to about 90° C.

At block S14, the precursor solution is placed in a solvothermal reaction reactor and heated at a second temperature to form the lithium iron phosphate. The second temperature is higher than the first temperature.

At block S11, the iron phosphate (FePO₄) can be in particle form. A diameter of the iron phosphate particle can be in a range from about 50 nanometers to about 2 microns. The iron phosphate can be formed from a ferric iron source reacting with a phosphate group (PO₄³⁺) source. The lithium chemical compound can be selected from lithium hydroxide (LiOH), lithium chloride (LiCl), lithium sulfate (Li₂SO₄), lithium nitrate (LiNO₃), lithium dihydrogen phosphate (LiH₂PO₄), lithium acetate (CH₃COOLi), and any combination thereof. The organic solvent can dissolve the lithium chemical compound. The lithium chemical compound can form lithium ions in the organic solvent. In addition, the organic solvent can be simultaneously used as a reducing agent to reduce trivalent iron ions (Fe³⁺) to divalent iron ions (Fe²⁺) during the solvothermal reaction. The organic solvent can be a diol solvent, polyol solvent, and/or a polymer polyol solvent, which can be selected from ethylene glycol, glycerol, diethylene glycol, triethylene glycol, tetraethylene glycol, 1,2,4-butanetriol (C₄H₁₀O₃), polyethylene glycol, and any combination thereof. The organic solvent can be selected depending on the selection of the lithium chemical compound. In one embodiment, the organic solvent is ethylene glycol.

In one embodiment, the lithium ion source solution does not contain any water. In another embodiment, the lithium ion source solution contains a small amount of water. In some embodiments, the selected lithium chemical compound is a lithium hydrate, such as LiOH.H₂O, and/or the selected iron phosphate is an iron hydrate. When dissolving the lithium chemical compound in the organic solvent and then mixing with the iron phosphate, water of crystallization in the lithium hydrate and/or the iron hydrate is introduced into the mixture. However, a volume ratio of water to organic solvent is not more than 1:10, to avoid affecting the crystallization of the lithium iron phosphate and obtain a uniform morphology and structure. In one embodiment, the volume ratio is smaller than 1:50.

A concentration of lithium ions in the lithium ion source solution can be in a range from about 0.5 mol/L to about 0.7 mol/L. In the above concentration range, the greater the concentration of the lithium ions, the better the crystallization of generated olivine type lithium iron phosphate. When the concentration of lithium ions in the lithium ion source solution is smaller than the above concentration range, the generated lithium iron phosphate will include impurity phases. When the concentration of lithium ions in the lithium ion source solution is larger than the above concentration range, the generated lithium iron phosphate will have poor crystallization. In one embodiment, the concentration of lithium ions in the lithium ion source solution is about 0.6 mol/L.

At block S12, a molar ratio of Li to Fe in the mixture is about (1-2):1. That is, in the mixture, the Fe element takes 1 part and the Li element takes 1-2 parts. In one embodiment, the molar ratio of Li to Fe is about 1:1.

Before block S12, the iron phosphate can be predispersed in the organic solvent to form a dispersion liquid, and then the dispersion liquid is mixed with the lithium ion source solution. Thus, the iron phosphate and the lithium chemical compound can be uniformly mixed in the mixture. In one embodiment, the organic solvent of the dispersion liquid is same as the organic solvent of the lithium ion source solution. In another embodiment, the organic solvent of the dispersion liquid is different from the organic solvent of the lithium ion source solution.

At block S12, a stirring step can be included during the mixing of the iron phosphate and the lithium ion source solution. Thus, the iron phosphate and the lithium ion source solution can be uniformly mixed in the mixture. A manner of stirring can be a mechanical agitation or an ultrasonic dispersion. A stirring time can be in a range from about 0.5 hour to 2 hours. A stirring velocity can be in a range from about 60 revolutions per minute (rpm) to about 600 rpm.

At block S12, the iron phosphate can be added to the lithium ion source solution to form the mixture, or the lithium ion source solution can be added to the iron phosphate to form the mixture. In one embodiment, the iron phosphate is gradually added to the lithium ion source solution, and the iron phosphate and the lithium ion source solution are uniformly mixed under continuous stirring to form the mixture.

A total concentration of the iron phosphate and the lithium chemical compound in the mixture is less than or equal to 1.5 mol/L. In one embodiment, the total concentration of the iron phosphate and the lithium chemical compound is in a range from about 1.1 mol/L to about 1.4 mol/L. In another embodiment, the total concentration of the iron phosphate and the lithium chemical compound is 1.2 mol/L. When the total concentration of the iron phosphate and the lithium chemical compound is too great, the subsequent reacting process will produce unevenness.

At block S13, a heating step, of the mixture at the first temperature, can be conducted under a normal pressure (e.g., one atmosphere). The heating step can take place in an open environment.

In one embodiment, the first temperature can be in a range from about 40° C. to about 90° C. In another embodiment, the first temperature can be in a range from about 60° C. to about 80° C. In some embodiments, the first temperature is about 80° C. Lithium, iron, and phosphorus all become solid phases in the precursor solution formed by heating the mixture at the first temperature. During the heating step, a morphology of the iron phosphate particles is changed from a solid spherical structure to a hollow and porous structure in the precursor solution, and a complex is formed from the reacting of the lithium hydroxide with the organic solvent. The complex comprises C, H, and O elements and these are adsorbed in micropores of the iron phosphate particles. Thus, the lithium chemical compound, iron phosphate, and the organic solvent can be uniformly distributed. Accordingly, the temperature of the solvothermal reaction can be decreased, and the lithium iron phosphate with high degrees of crystallinity can be quickly formed and uniformly dispersed.

At block S13, the mixture can be uniformly heated in a water bath or an oil bath. A heating apparatus can be provided and preheated to the first temperature, and then the mixture can be placed in the heating apparatus to keep the first temperature. In one embodiment, a water bath heating apparatus is preheated to the first temperature, and then the mixture is placed in the water bath heating apparatus to keep the first temperature. In addition, the mixture can be further uniformly heated by stirring during the heating step.

At block S13, a heating time of the mixture is in a range from about 1 hour to about 8 hours. In one embodiment, the heating time of the mixture is in a range from about 4 hours to about 6 hours.

Block S12 and block S13 can be applied simultaneously.

At block S14, the solvothermal reaction reactor may be a sealed autoclave. An internal pressure of the sealed autoclave can be increased by applying an outer pressure to the autoclave or self-generating a pressure by internal steam pressure. Thus, the precursor solution inside the solvothermal reaction reactor can undergo a reaction at a high temperature and a high pressure. The internal pressure of the solvothermal reaction reactor can be about 5 MPa˜30 MPa.

A filling rate of the precursor solution in the solvothermal reaction reactor is about 60%˜80%. In one embodiment, the filling rate of the precursor solution in the solvothermal reaction reactor is 80%.

The precursor solution can be stirred inside the solvothermal reaction reactor which is sealed.

After the precursor solution is added into the solvothermal reaction reactor, the precursor solution can be heated while being stirred. A mass transfer process will be uniform, and the iron phosphate can easily react with the lithium ion source solution under the continuous stirring. In addition, size, dispersion, and crystallinity of the lithium iron phosphate can be controlled by stirring the precursor solution. A stirring velocity of the mixture can be in a range from about 30 rpm to about 100 rpm.

At block S14, the solvothermal reaction reactor can be placed in a blast drying oven to process the solvothermal reaction. The blast drying oven can heat the solvothermal reaction reactor to a predetermined temperature and keep the predetermined temperature. A temperature of the solvothermal reaction reactor can be better controlled by the blast drying oven.

The second temperature is greater than the first temperature. The second temperature can be in a range from about 120° C. to about 250° C. In one embodiment, the second temperature can be in a range from about 150° C. to about 200° C. After the precursor solution is placed into the solvothermal reaction reactor, the solvothermal reaction reactor is gradually heated to the second temperature. A solvothermal reaction time is in a range from about 3 hours to about 12 hours. After completion of the solvothermal reaction, the solvothermal reaction reactor can be allowed to cool naturally to a room temperature to achieve a reaction product. The reaction product is the lithium iron phosphate.

The reaction product can be washed by deionized water, filtered, centrifuged several times, and dried.

A shape of the lithium iron phosphate particles is spindle. The lithium iron phosphate particles are uniformly dispersed. The lithium iron phosphate particles have a uniform diameter. The diameter of lithium iron phosphate particles is in range from about 50 nanometers to about 200 nanometers. The lithium iron phosphate particles have a small diameter and good crystallinity, as proved by XRD analysis. Thus, the lithium iron phosphate particles can be directly used as the cathode active material without any high-temperature treatment.

Furthermore, the lithium iron phosphate can be coated with carbon. The carbon-coating process can include the following steps:

T1, preparing a liquid solution of a carbon source chemical compound;

T2, adding the lithium iron phosphate into the liquid solution of the carbon source chemical compound to form a solid-liquid mixture; and

T3, heating the solid-liquid mixture.

The carbon source chemical compound can be a reductive organic chemical compound. The reductive organic chemical compound can be pyrolyzed in an oxygen-free environment to form elemental carbon (e.g., amorphous carbon). The pyrolysis step does not generate any other solid phase substance. The carbon source chemical compound can be selected from, saccharose, dextrose, SPAN 80, phenolic resin, epoxide resin, furan resin, polyacrylic acid, polyacrylonitrile, polyethylene glycol, or polyvinyl alcohol. The carbon source chemical compound is dissolved in a solvent such as organic solvent and/or deionized water to form the liquid solution having a concentration in a range from about 0.005 grams per milliliter (g/ml) to about 0.05 g/ml. After adding the lithium iron phosphate into the liquid solution of the carbon-source chemical compound, the lithium iron phosphate is uniformly coated with the liquid solution of the carbon-source chemical compound by stirring. In one embodiment, a vacuum can be applied to the solid-liquid mixture to evacuate air between the lithium iron phosphate particles. In one embodiment, the lithium iron phosphate coated with the liquid solution of the carbon-source chemical compound can be centrifuged and dried before heating the solid-liquid mixture. Heating the solid-liquid mixture can comprise two steps, first, heating the solid-liquid mixture up to a third temperature and maintaining the third temperature; second, heating the solid-liquid mixture up to a fourth temperature and calcining the solid-liquid mixture. Carbon will uniformly coat surfaces of the lithium iron phosphate by the above two steps of heating the solid-liquid mixture. The third temperature can be in a range from about 150° C. to about 200° C. and keep the third temperature for about 1 hour to about 3 hours. The fourth temperature can be in a range from about 300° C. to about 800° C. The time period of calcining the solid-liquid mixture can be in a range from about 0.3 hour to about 8 hours. In one embodiment, the solid-liquid mixture is heated and kept at 200° C. for 1 hour, and then heated to 650° C. and calcined for 5 hours.

### Example 1

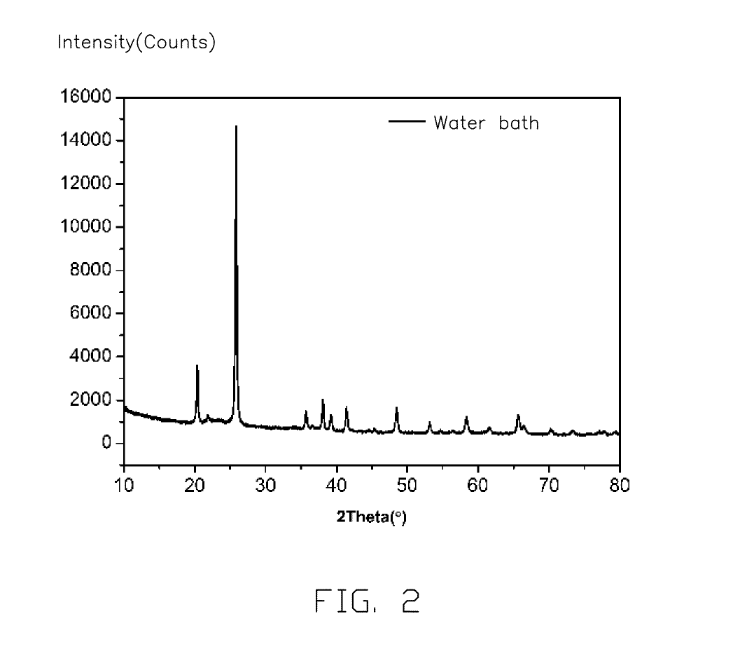

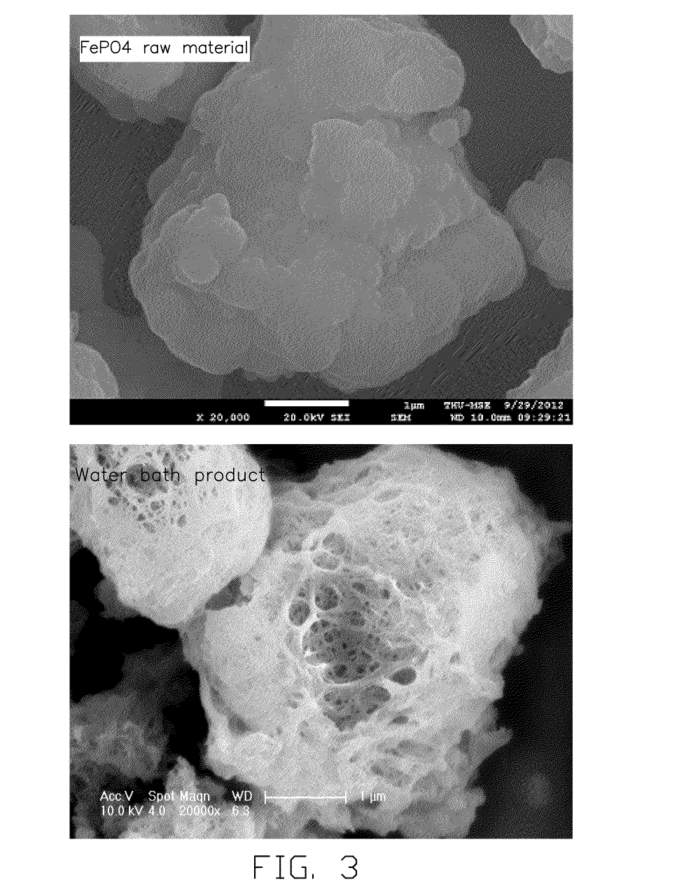

In Example 1, the lithium chemical compound is LiOH.H₂O, and the organic solvent is ethylene glycol. The molar ratio of LiOH.H₂O to FePO₄ is about 1:1. The LiOH.H₂O is dissolved in 40 mL of ethylene glycol to form the lithium ion source solution. The concentration of the lithium ion source solution is 0.6 mol/L. The FePO₄ particles are added to the lithium ion source solution and ultrasonically vibrated for 30 minutes to form the mixture. After the mixture is placed in a water bath, the mixture is heated to and kept at about 80° C. for about 4 hours to form the precursor solution. Referring to FIG. 2, the solid phase substance in the precursor solution is the FePO₄ having a good degree of crystallinity, by XRD analysis. Referring to FIG. 3, the morphology of the FePO₄ changes from solid particles to porous structure in the water bath process. Referring to Table 1, the precursor solution is tested by inductively coupled plasma atomic emission spectrometry (ICP-AES). It shows that a supernatant of the precursor solution is almost free of Fe and P, and an Li content is very small. In the solid phase substance, a molar ratio of Fe to Li is about 1:1 (a mass ratio of Fe and Li is about 32.594%, a mass ratio of other elements is about 67.406%). The solid phase substance contains C and H elements. Referring to FIG. 2, FIG. 3, and Table 1, the Fe, Li, and P substantially become solid phase, and the solid phase substance also comprises C, H, and O elements after the water bath process. The Fe, P, and O elements exist in the form of FePO₄. The Li, C, H, and O elements are adsorbed in the micropores of the FePO₄.

TABLE 1

| supernatant of | | | | | |
|---|---|---|---|---|---|
| the precursor | | solid phase | mass | solid phase | mass |
| solution | μm/mL | substance | ratio % | substance | ratio % |
| Fe | 51.59 | Fe | 28.88 | C | 7.03 |
| Li | 90.88 | Li | 3.714 | H | 1.42 |
| P | 3.908 | | | | |

The mixture is transferred to the solvothermal reaction reactor (the filling rate is about 80%) and stirred at a rate of 50 rpm. The reaction takes place at about 200° C. for about 6 hours to form the reaction product. The reaction product is washed with ethanol and water and dried at 80° C. to obtain the lithium iron phosphate.

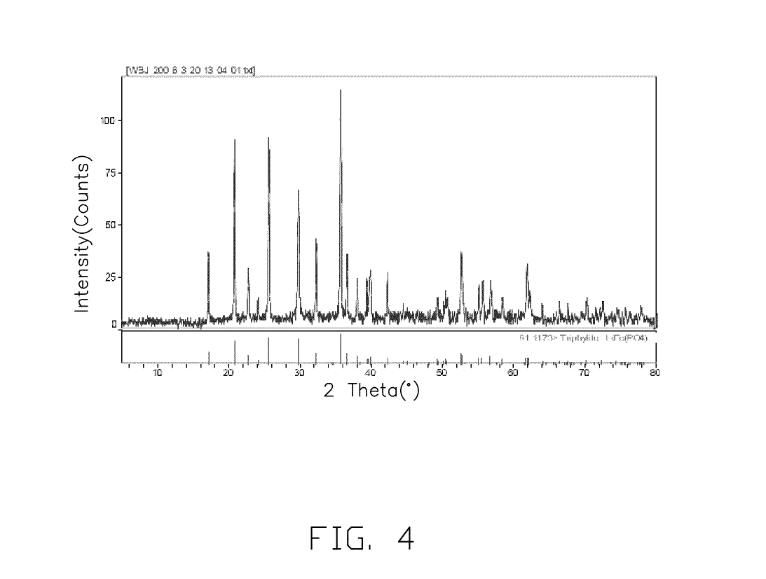

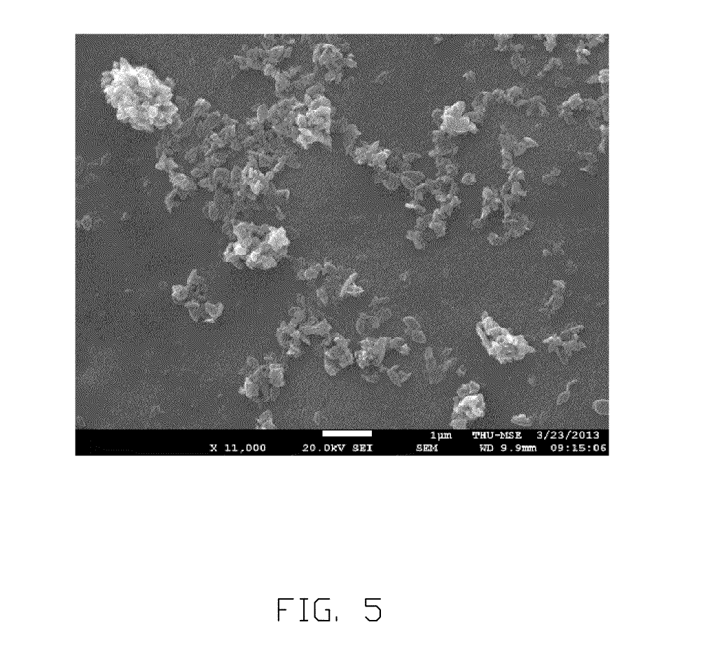

Referring to FIG. 4, the XRD pattern shows that pure-phase and well-crystallized lithium iron phosphate is obtained. Referring to FIG. 5, the lithium iron phosphate is well-dispersed, the morphology of the lithium iron phosphate is spindle particles, the particle size of the lithium iron phosphate is substantially the same, and the diameter of the lithium iron phosphate particles is in a range from about 300 nm to about 400 nm.

The lithium iron phosphate is mixed with sugar (carbon content is about 5%) to form a mixture. The mixture is placed in an agate mortar and grinded for 20 minutes, and then placed in a tube furnace at 200° C. for 1 hour. The mixture is then calcined at 650° C. for 5 hours to obtain a carbon coated lithium iron phosphate particle. The cathode electrode is formed by mixing the carbon coated lithium iron phosphate, an acetylene black, a graphite, and a polyvinylidene fluoride. A mass percentage of the carbon coated lithium iron phosphate is 80%. A mass percentage of the acetylene black is 5%. A mass percentage of the graphite is 5%. A CR2032 type button battery is assembled in a glove box filled with an argon atmosphere, using a lithium metal foil as an anode electrode, a Celgard 2400 microporous polypropylene membrane as a separator, and 1 mol/L LiPF₆/EC+DMC+EMC as an electrolyte. A volume ratio for the EC, DMC, and EMC is 1:1:1. The CR2032 type button battery is tested at room temperature.

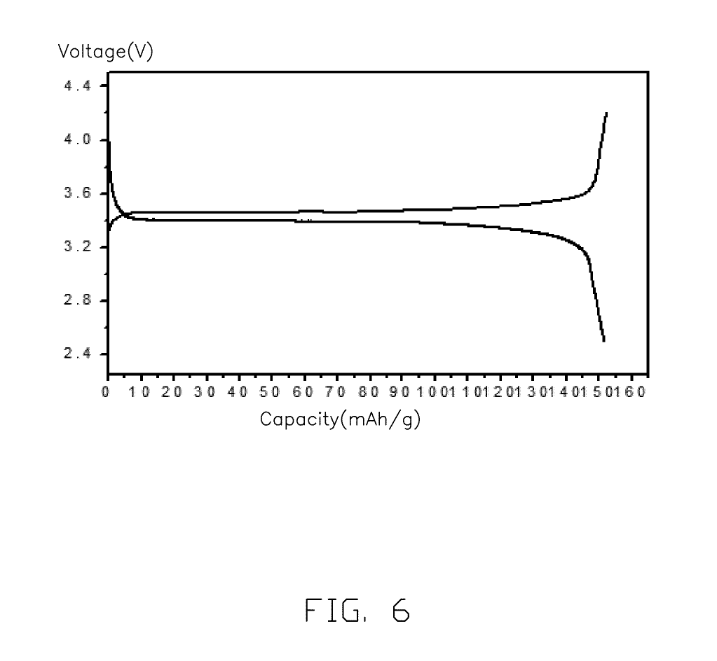

Referring to FIG. 6, the first charge/discharge specific capacities of the button battery made by the method of the Example 1 is high, respectively 152.2 mAh/g and 151.5 mAh/g. A first coulombic efficiency of the button battery made by the method of the Example 1 is about 99.6%, and a voltage difference between the charge and discharge voltages is small. The button battery made by the method of Example 1 is charged and discharged 20 times using a current rate of 0.1 C (100 uA/cm²), and about 98.6% of the capacity is maintained.

### Comparative Example 2

The method in Example 2 is substantially the same as the method in Example 1, except that the concentration of the lithium ion source solution is 0.2 mol/L.

### Comparative Example 3

The method in Example 3 is substantially the same as the method in Example 1, except that the concentration of the lithium ion source solution is 0.4 mol/L.

### Comparative Example 4

The method in Example 4 is substantially the same as the method in Example 1, except that the concentration of the lithium ion source solution is 0.8 mol/L.

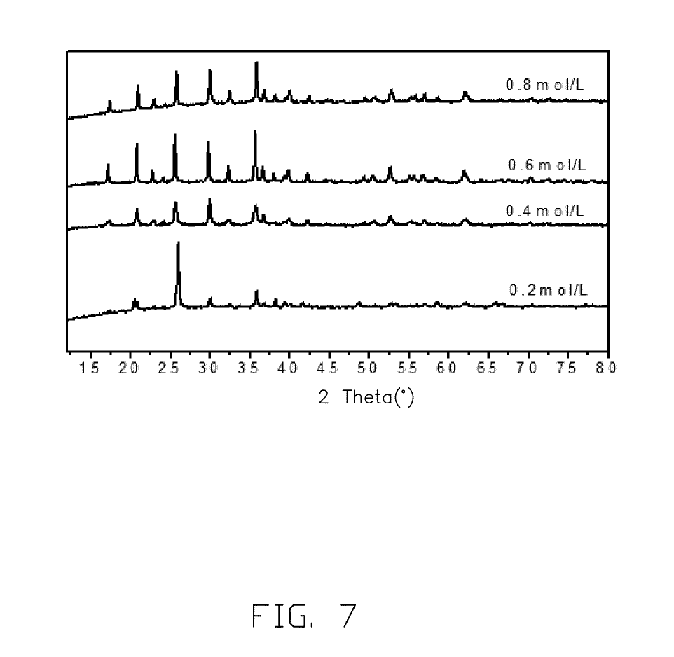

Referring to FIG. 7, all the XRD patterns of the lithium iron phosphate formed by the method of the Example 1 and Comparative Example 2-4 are compared. The lithium iron phosphate formed by the method of the Comparative Example 2 and 3 include iron phosphate impurities. The lithium iron phosphate formed by the method of the Example 1 and Comparative Example 4 are pure. A crystallinity of the lithium iron phosphate formed by the method of the Example 1 is better than a crystallinity of the lithium iron phosphate formed by the method of the Comparative Example 4.

### Comparative Example 5

The method in Comparative Example 5 is substantially the same as the method in Example 1, except that the method in Comparative Example 5 does not comprise the step of heating the mixture by the water bath, nor stirring the mixture in the solvothermal reaction reactor.

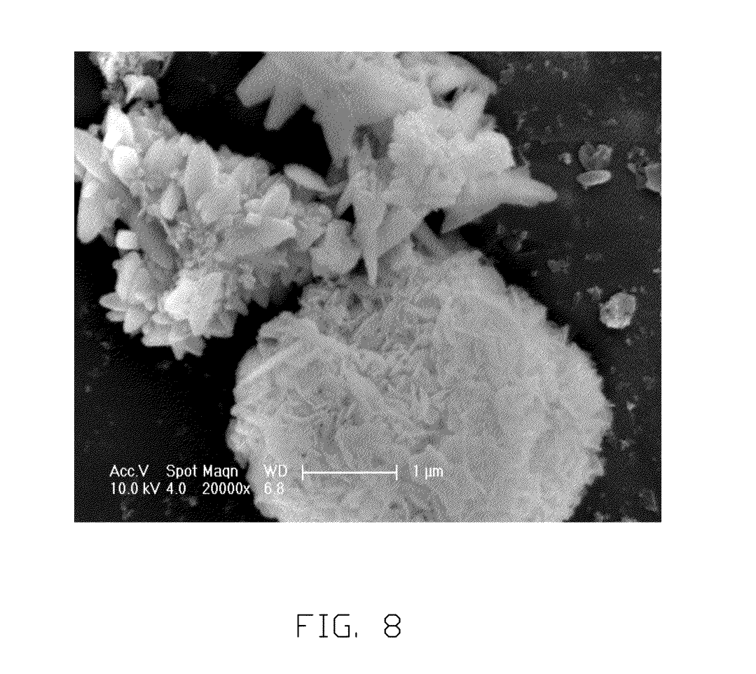

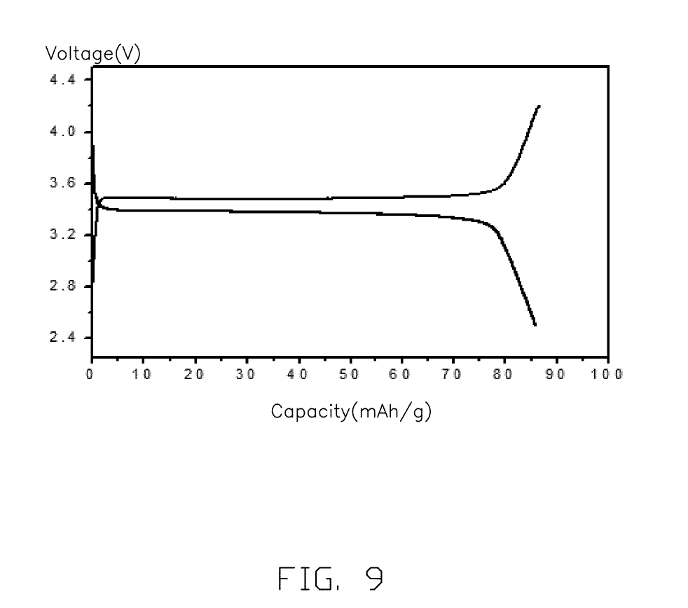

Referring to FIG. 8, the lithium iron phosphate formed by the method of the Comparative Example 5 is agglomerated. The particle size of the lithium iron phosphate is uneven. The lithium iron phosphate particles mainly have two sizes; the diameter of one size is in a range about 1 micron to about 2 microns, and the diameter of the other size is in a range about 300 nm to 400 nm. Referring to FIG. 9, first charge/discharge specific capacities of the button battery made by the method of the Comparative Example 5 is smalls, respectively 86.5 mAh/g and 86.5 mAh/g.

### Example 2

The method in Example 2 is substantially the same as the method in Example 1, except that the method in Example 2 does not comprise the step of stirring the mixture in the solvothermal reaction reactor.

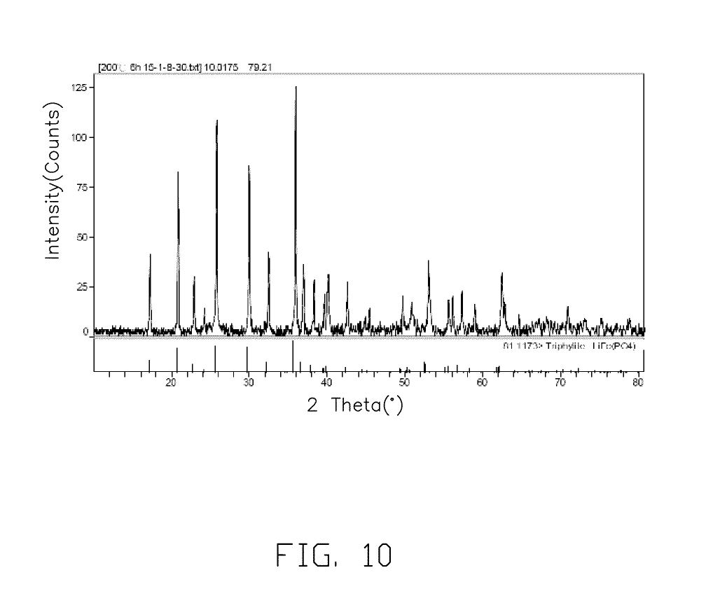

Referring to FIG. 10, the reaction product made by the method of the Example 2 is the olivine type lithium iron phosphate. Comparing FIG. 4 with FIG. 10, characteristic peaks of the lithium iron phosphate made by the method of the Example 1 are higher than characteristic peaks of the lithium iron phosphate made by the method of the Example 2. The lithium iron phosphate made by the method of the Example 2 has small agglomeration. The morphology of the lithium iron phosphate made by the method of the Example 2 is spindle particle, and the diameter of the lithium iron phosphate particle is in a range from about 600 nm to about 800 nm.

A button battery is assembled using the cathode electrode of the Example 2, an anode electrode, an electrolyte, and a separator. The anode electrode, the electrolyte and the separator of the button battery in the Example 2 is the same as the anode electrode, the electrolyte, and the separator of the button battery in the Example 1.

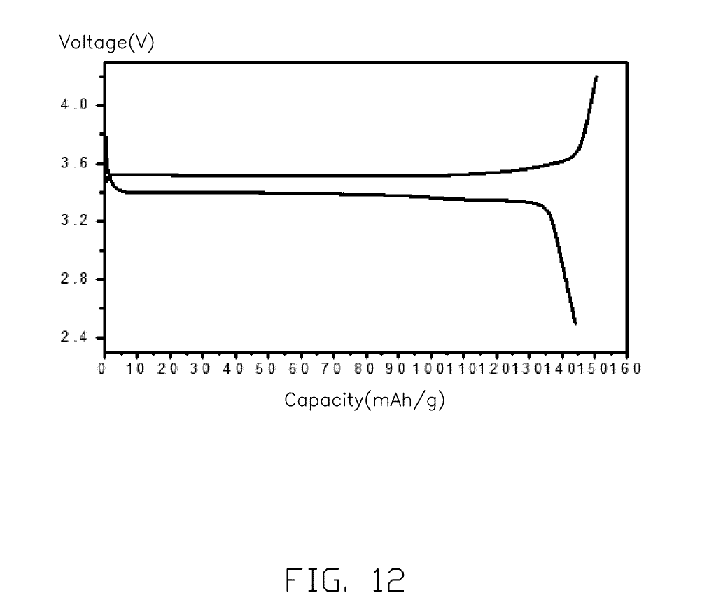

Referring to FIG. 12, first charge/discharge specific capacities of the button battery in the Example 2 are respectively 150.6 mAh/g and 144.1 mAh/g. A first coulombic efficiency of the button battery in the Example 2 is about 95.7%. The button battery in the Example 2 is charged and discharged 20 times at a current rate of 0.1 C (100 uA/cm²), and about 98% of the capacity is maintained.

The lithium iron phosphate can be made as the cathode active material by solvent-thermal method. In this method, the lithium iron phosphate is synthesized by using a ferric iron source as a raw material to achieve cost reduction. The iron phosphate and the lithium iron source solution are mixed to form the mixture, and the mixture is heated to form the precursor solution before the solvothermal reaction. Morphology and binding mode of the raw materials are changed by heating the mixture, the raw materials can be well dispersed. Thus, the temperature of the solvothermal reaction can be decreased, well-crystallized lithium iron phosphate can be quickly formed, and the lithium iron phosphate particles are well dispersed. The method for making the lithium iron phosphate is simple. The lithium iron phosphate as the cathode active material has good electrochemical properties.

Depending on the embodiment, certain of the steps of methods described may be removed, others may be added, and the sequence of steps may be altered. It is also to be understood that the description and the claims drawn to a method may comprise some indication in reference to certain steps. However, the indication used is only to be viewed for identification purposes and not as a suggestion as to an order for the steps.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for making a lithium iron phosphate comprising:
providing a lithium ion source solution and an iron phosphate, wherein the lithium ion source solution comprises an organic solvent and a lithium chemical compound dissolved in the organic solvent;
mixing the lithium ion source solution and the iron phosphate to form a mixture;
heating the mixture at a first temperature under a normal pressure to form a precursor solution, wherein the first temperature is in a range from about 40° C. to about 90° C.; and
placing the precursor solution in a solvothermal reaction reactor and heating the precursor solution at a second temperature to form the lithium iron phosphate, wherein the second temperature is higher than the first temperature.

2. The method of claim 1, further comprising a step of stirring the precursor solution after placing the precursor solution in the solvothermal reaction reactor.

3. The method of claim 2, wherein a stirring velocity is in a range from about 30 revolutions per minute to about 100 revolutions per minute.

4. The method of claim 1, wherein the organic solvent is a diol solvent, polyol solvent or polymer polyol solvent.

5. The method of claim 4, wherein the organic solvent is selected from ethylene glycol, glycerol, diethylene glycol, triethylene glycol, tetraethylene glycol, 1,2,4-butanetriol (C₄H₁₀O₃), polyethylene glycol, and any combination thereof.

6. The method of claim 1, wherein a total concentration of the iron phosphate and the lithium chemical compound in the mixture is less than or equal to 1.5 mol/L.

7. The method of claim 1, wherein a morphology of the iron phosphate is changed from a solid spherical structure to a hollow porous structure in the precursor solution.

8. The method of claim 1, wherein a concentration of lithium ions in the lithium ion source solution is in a range from about 0.5 mol/L to about 0.7 mol/L.

9. The method of claim 1, wherein a heating apparatus is provided and preheated to the first temperature, and then the mixture is placed in the heating apparatus to keep the first temperature.

10. The method of claim 1, wherein the second temperature is in the range from about 120° C. to about 250° C.

11. The method of claim 1, wherein a filling rate for the precursor solution in the solvothermal reaction reactor is about 60%˜80%.
